(19) United States
(12) Patent Application Publication
(10) Pub. No.: US 2017/0270566 A1
(43) Pub. Date: Sep. 21, 2017

(54) Method of Displaying Product Information

(71) Applicant: Vasudevan M. Vamanamoorthy, Watervliet, NY (US)

(72) Inventor: Vasudevan M. Vamanamoorthy, Watervliet, NY (US)

(21) Appl. No.: 15/277,789

(22) Filed: Sep. 27, 2016

Related U.S. Application Data
(60) Provisional application No. 62/308,720, filed on Mar. 15, 2016.

(51) Int. Cl. G06Q 30/02; H04L 12/58; G06K 9/00; H04L 29/08

(52) U.S. Cl. CPC G06Q 30/0269; H04L 67/12; H04L 67/06; H04L 51/04; H04L 67/306; G06K 9/00288

(57) ABSTRACT

A method of displaying product information is used to display prices, information, and advertisements for in-store products. The method is performed by a system that includes a plurality of electronic retailer devices, at least one remote server, and at least one administrative computing device. The remote server manages a plurality of displayable content files and a plurality of additional feature options. The administrative computing device determines which displayable content files are displayed on individual electronic retailer devices. The administrative device prompts a user to select a desired file from the plurality of content files and select a specific device from the plurality of electronic retailer devices. The desired file is sent from the server to the specific device and is output by the specific device. The method also includes executing additional feature options with the administrative computing device or an arbitrary device from the plurality of electronic retailer devices.

The current application claims a priority to the U.S. Provisional Patent application Ser. No. 62/308,720 filed on Mar. 15, 2016.

### FIELD OF THE INVENTION

The present invention relates generally to in-store methods of displaying product information. More specifically, the present invention is a method of displaying prices, information, and advertisements for products using retailer computing devices.

### BACKGROUND OF THE INVENTION

In-store displays are commonly used to advertise new products and sales or show product pricing and information. In-store displays are most often made from paper or cardboard. Using cardboard or paper forces retailers to reprint displays and prices as sales occur or as product inventory changes. This approach leads to large amounts of paper waste. Common in-store displays may also be unclear, especially if similar products are placed in close proximity to each other. Since many prices include vary little additional information, consumers may be forced to search for assistance from a clerk. This can lead to worsened consumer approval ratings.

Accordingly, there is a present need for an updated method of displaying product related information. The present invention is a method of displaying product information that uses a plurality of electronic retailer devices to show product prices, advertisements, and information. A plurality of displayable content files is managed by a remote server and may be selected by an administrative computing device for display on individual electronic retailer devices. This method allows for information to be easily updated as products are added or removed from the store inventory. Further, the use of electronic retailer devices allows for additional feature options to be utilized to enhance the overall consumer experience.

### BRIEF DESCRIPTION OF THE DRAWINGS

FIG. 1 is a schematic view for the system used by the present invention.

FIG. 2 is a schematic view for the system used by the present invention, wherein the at least one administrative computing device comprises the store computing device and the vendor computing device.

FIG. 3 is a flowchart for the overall process of the present invention.

FIG. 4 is a flowchart describing the steps of providing a product-based identifier for the electronic retailer devices.

FIG. 5 is a flowchart describing the steps of providing a store location for the electronic retailer devices.

FIG. 6 is a flowchart describing the steps of prompting to select the desired file and the desired device using the vendor computing device and the store computing device.

FIG. 7 is a flowchart describing the steps of prompting to select the desired file and the desired device using the vendor computing device.

FIG. 8 is a flowchart describing the steps of executing the store assistance feature as the desired feature.

FIG. 9 is a flowchart describing the steps of executing the virtual chat feature as the desired feature.

FIG. 10 is a flowchart describing the steps of using consumer facial profile to initiate the virtual chat feature as the desired feature.

FIG. 11 is a flowchart describing the steps of executing the store announcement feature as the desired feature.

FIG. 12 is a flowchart describing the steps of executing the price-check feature as the desired feature.

FIG. 13 is a flowchart describing the steps of executing the surveillance feature as the desired feature.

FIG. 14 is a flowchart describing the steps of executing the product-ordering feature as the desired feature.

### DETAILED DESCRIPTION OF THE INVENTION

All illustrations of the drawings are for the purpose of describing selected versions of the present invention and are not intended to limit the scope of the present invention.

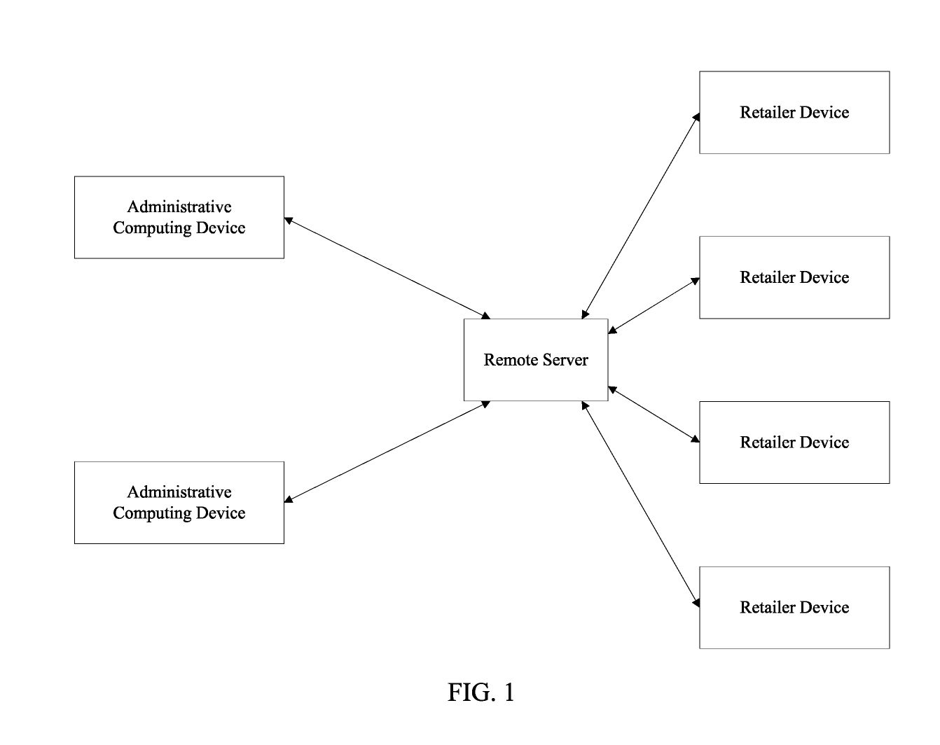

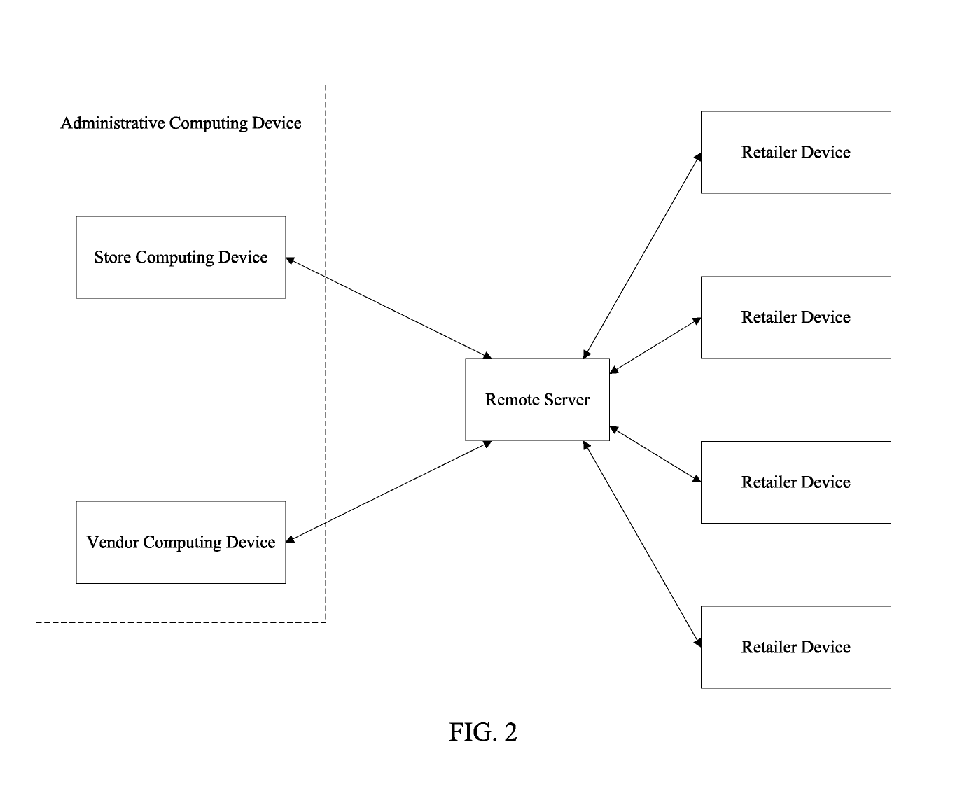

With reference to FIGS. 1-3, the present invention is a method of displaying product information. The present invention is used to display product prices, advertisements, and other information in a retail store. In order to perform the method of the present invention, a system comprising a plurality of electronic retailer devices is provided. Each of the plurality of electronic retailer devices is used to display information for individual products. The plurality of electronic retailer devices can include but is not limited to tablets, computers, and smart televisions. Further, televisions or monitors may be integrated into the system of the present invention through the use of an attachable computing device. The system further comprises at least one administrative device. The administrative device is used to manage each of the plurality of electronic retailer devices. The system further comprises at least one remote server. The remote server is used to manage a plurality of displayable content files and a plurality of additional feature options. The plurality of displayable content files is used to relay information about a product to consumers. Each of the plurality of additional feature options may be executed in order to enhance a consumer's experience or to improve how the retail store operates.

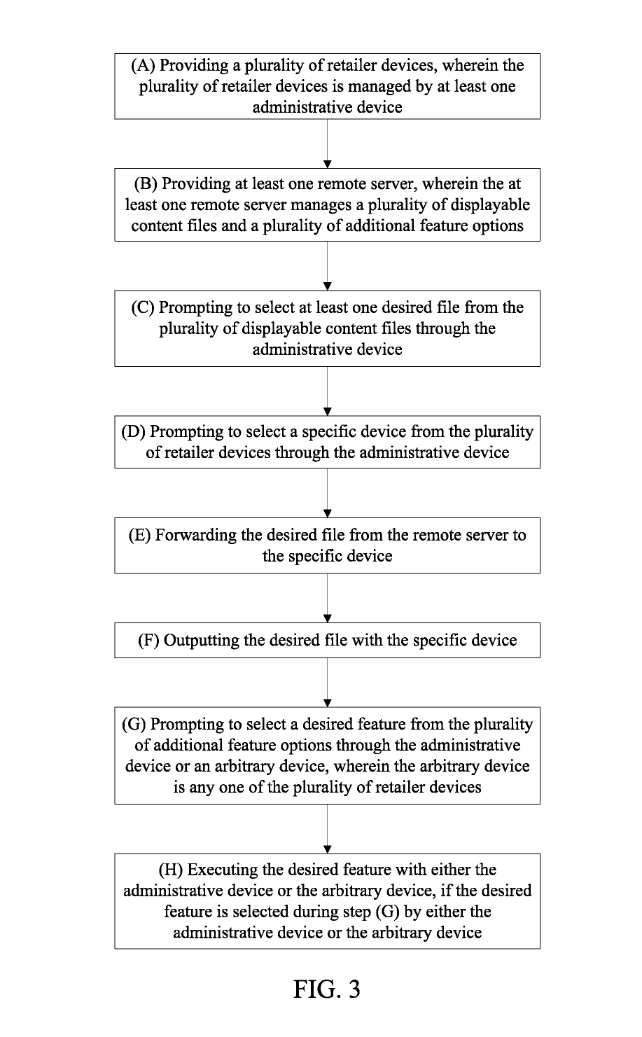

In reference to FIG. 3, to initiate the method of the present invention, the administrative device prompts a retailer or a vendor to select at least one desired file from the plurality of displayable content files. The administrative device also prompts the retailer or vendor to select a specific device from the plurality of electronic retailer devices. The two selections made through the administrative device are made to choose what is displayed by the specific device. Upon receiving both selections, the desired file is forwarded from the remote server to the specific device. The specific device outputs the desired file. Outputting the desired file may entail displaying pictures or video, playing sound, displaying text, or displaying a webpage. This can include displaying prices or barcodes, playing advertisements, displaying product information or warnings, as well as displaying store information. In addition to outputting the desired file, the method of the present invention may be used to execute the additional feature options. To do so, a consumer is prompted to select a desired feature from the plurality of additional feature options through an arbitrary device from the plurality of electronic retailer devices or a retailer is prompted to select a desired feature through the administrative device. If the desired feature is selected during step G by either the administrative device or the arbitrary device, the desired feature is executed with either the administrative device or the arbitrary device.

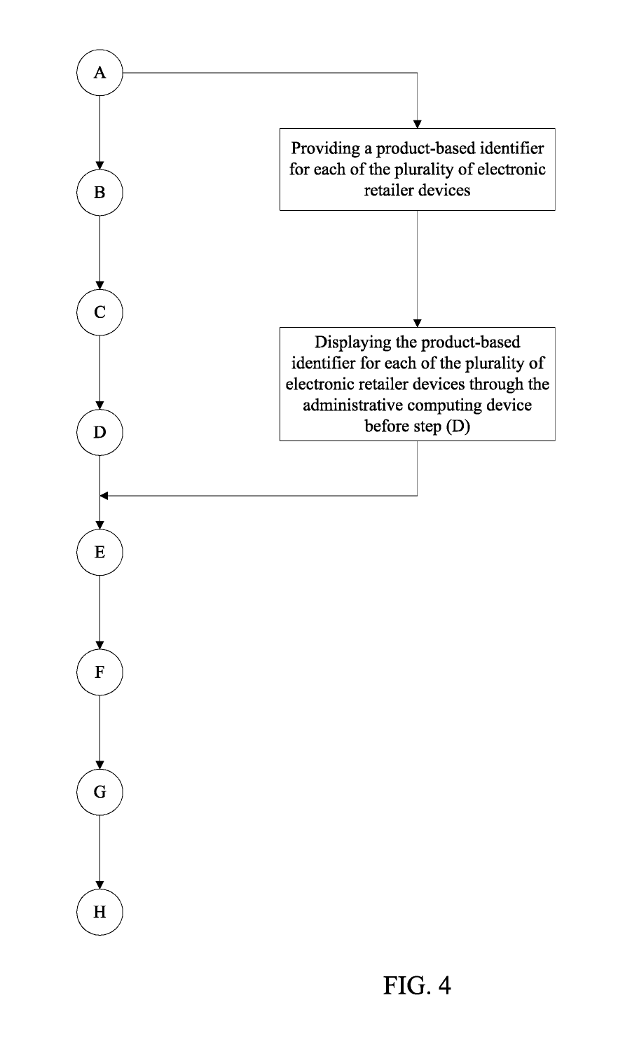

In reference to FIG. 4, in the preferred embodiment of the present invention, a product-based identifier is provided for each of the plurality of electronic retailer devices. The product based identifier is used to link each of the electronic retailer devices with the individual products being sold nearby. The product-based identifier for each of the plurality of electronic retailer devices is displayed through the administrative computing device before step D. This is done to easily organize which displayable content files are displayed on each of the electronic retailer devices. For example, if the desired file contains the pricing and product information for a pair of shoes, the product-based identifier will help to select the specific device which is located near the pair of shoes.

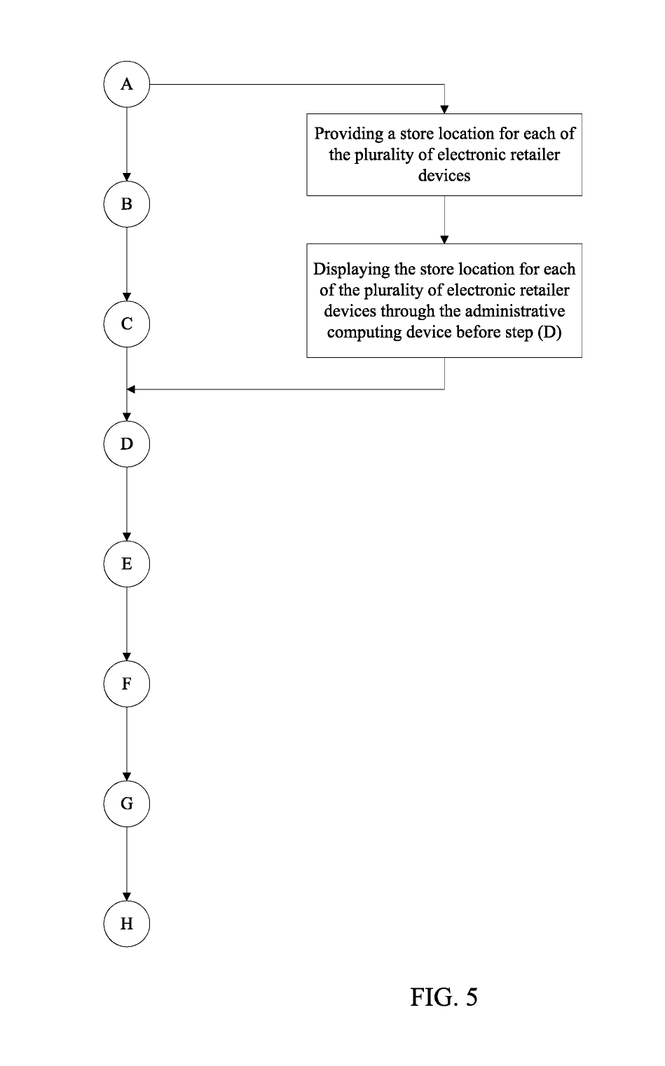

In reference to FIG. 5, a store location may, alternatively, be provided for each of the plurality of electronic retailer devices. The store location functions similarly to the product-based identifier in that the store location can be used to target one or more of the electronic retailer devices. The store location for each of the plurality of electronic retailer devices is displayed through the administrative computing device before step D. Like with the product-based identifier, this is done to organize which displayable content files are displayed on each of the electronic retailer devices.

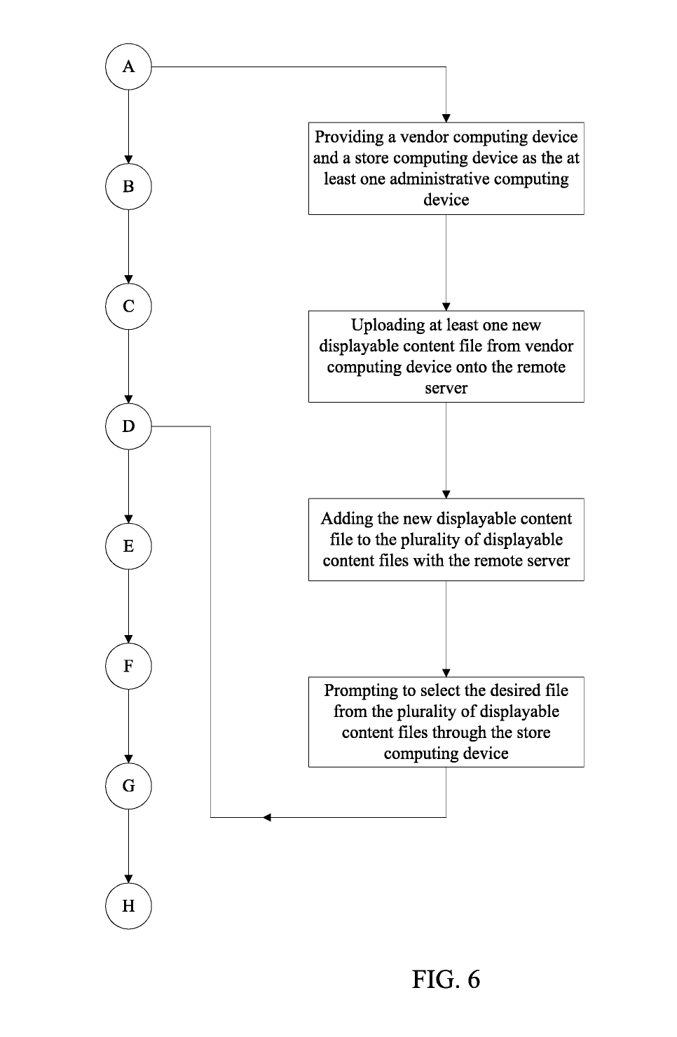

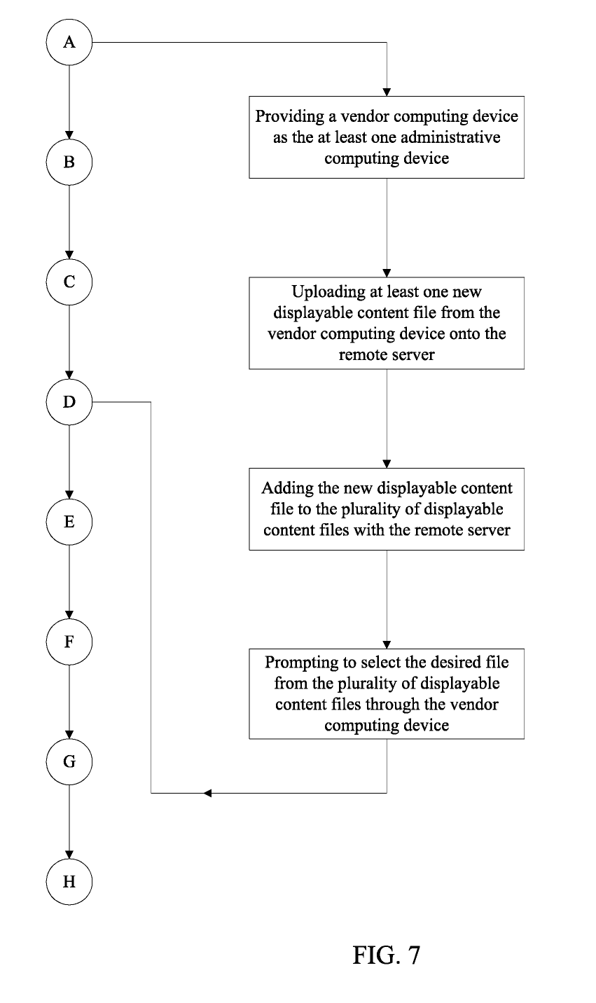

In reference to FIG. 6, in the preferred embodiment of the present invention, the at least one administrative computing device comprises a vendor computing device and a store computing device. The vendor computing device is managed by a manufacturer or a vendor of goods. The store computing device is managed by a retailer that sells the goods produced by the vendor. As new products or advertisements for products are created, the displayable content files must be updated accordingly. To do this, at least one new displayable content file is uploaded from the vendor computing device onto the remote server. The remote server adds the new displayable content file to the plurality of displayable content files in order to make the new displayable content file available to each of the electronic retailer devices. The store computing device is used to prompt the retailer to select the desired file from the plurality of displayable content files through the store computing device. This allows the retailer to decide which displayable content files best represent the inventory of the store. In reference to FIG. 7, in an alternative embodiment of the present invention, the vendor computing device prompts a vendor to select the desired file from the plurality of displayable content files. This allows the vendor to choose which displayable content files are used for the products in which the vendor creates. This method allows the retailer to charge the vendor for advertisement space. Further, both the retailer and the vendor may be charged for the use of the aforementioned method.

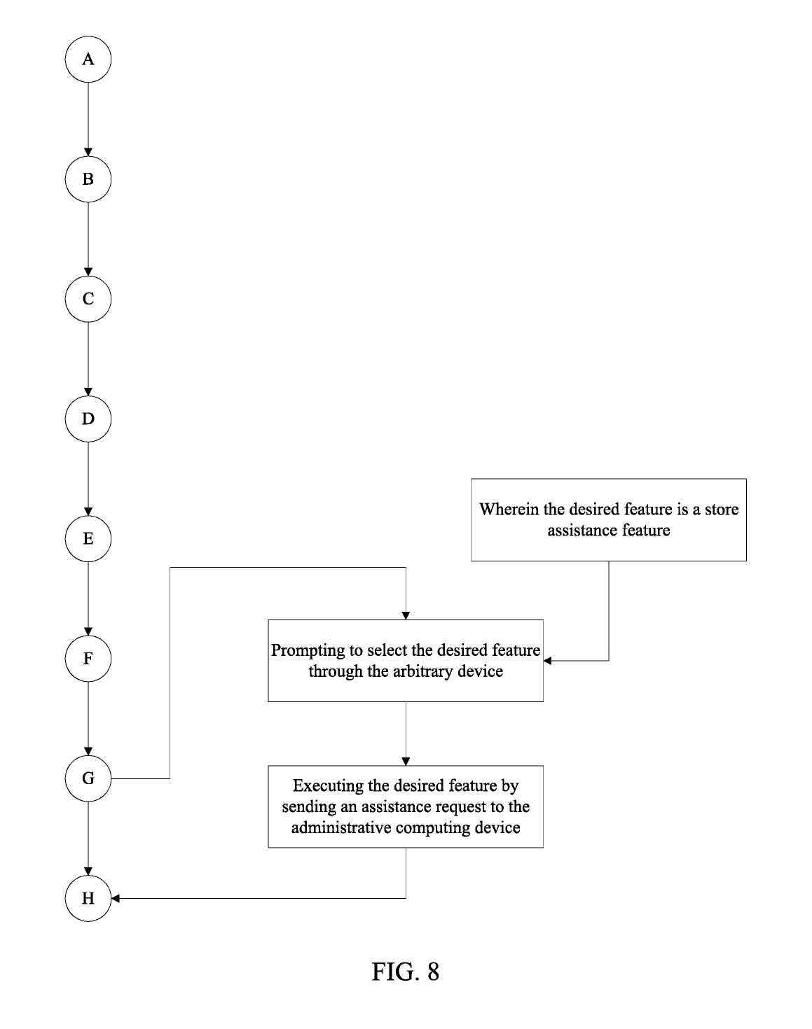

In reference to FIG. 8, one of the additional feature options is a store assistance feature which is used to request customer support. When the desired feature is the store assistance feature the consumer is prompted to select the desired feature through the arbitrary device. The desired feature is executed by sending an assistance request to the administrative computing device. The assistance request alerts the nearest representative to aid the consumer.

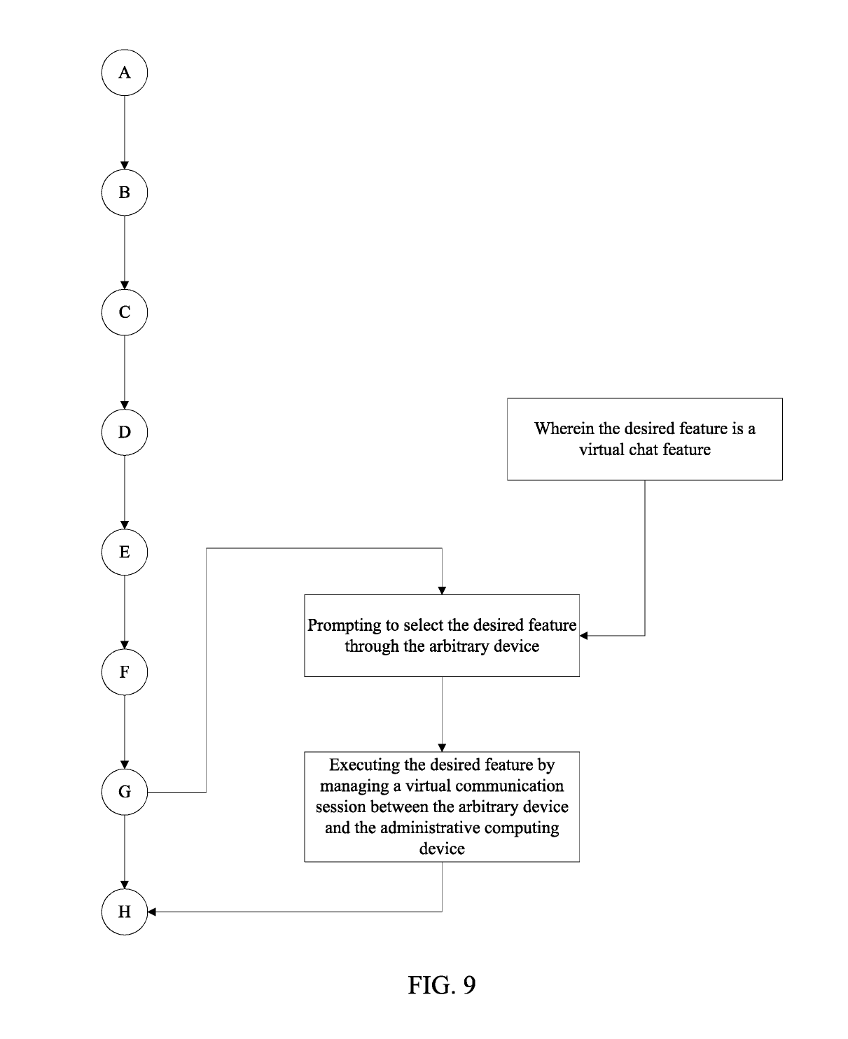

In reference to FIG. 9, a virtual chat feature is used as another means of assistance for consumers. When the virtual chat feature is the desired feature, the consumer is prompted to select the desired feature through the arbitrary device. In the preferred embodiment of the present invention, the arbitrary device prompts the consumer to select the virtual chat feature through a user interface. Once selected, the desired feature is executed by managing a virtual communication between the arbitrary device and the administrative computing device. The virtual communication between the arbitrary device and the administrative device may support audio, video, or text communication.

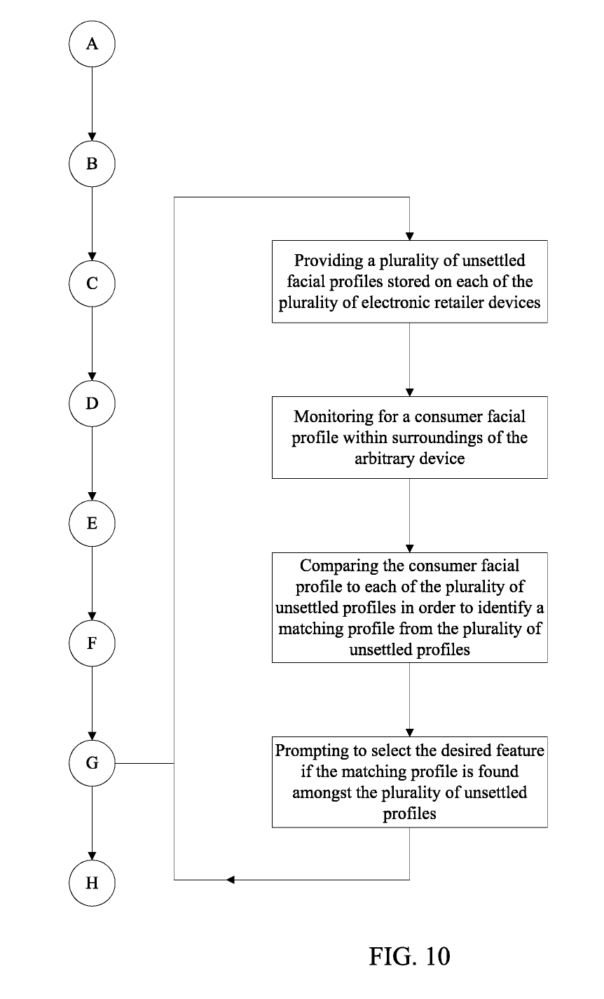

In reference to FIG. 10, in an alternative embodiment of the present invention, the virtual chat feature is initiated through the use of facial recognition. To do so, a plurality of unsettled facial profiles is stored on the arbitrary device and is used as points of reference to determine if a consumer needs assistance. The arbitrary device is used to monitor the surroundings of the arbitrary device for a consumer facial profile. The arbitrary device compares the consumer facial profile to each of the plurality of unsettled profiles in order to identify a matching profile from the plurality of unsettled profiles. This process is used to determine if the consumer is confused, lost, unhappy, or otherwise in need of assistance. If the matching profile is found amongst the plurality of unsettled profiles, the consumer is prompted to select the desired feature. Ultimately, the consumer is given the option to execute the virtual chat feature.

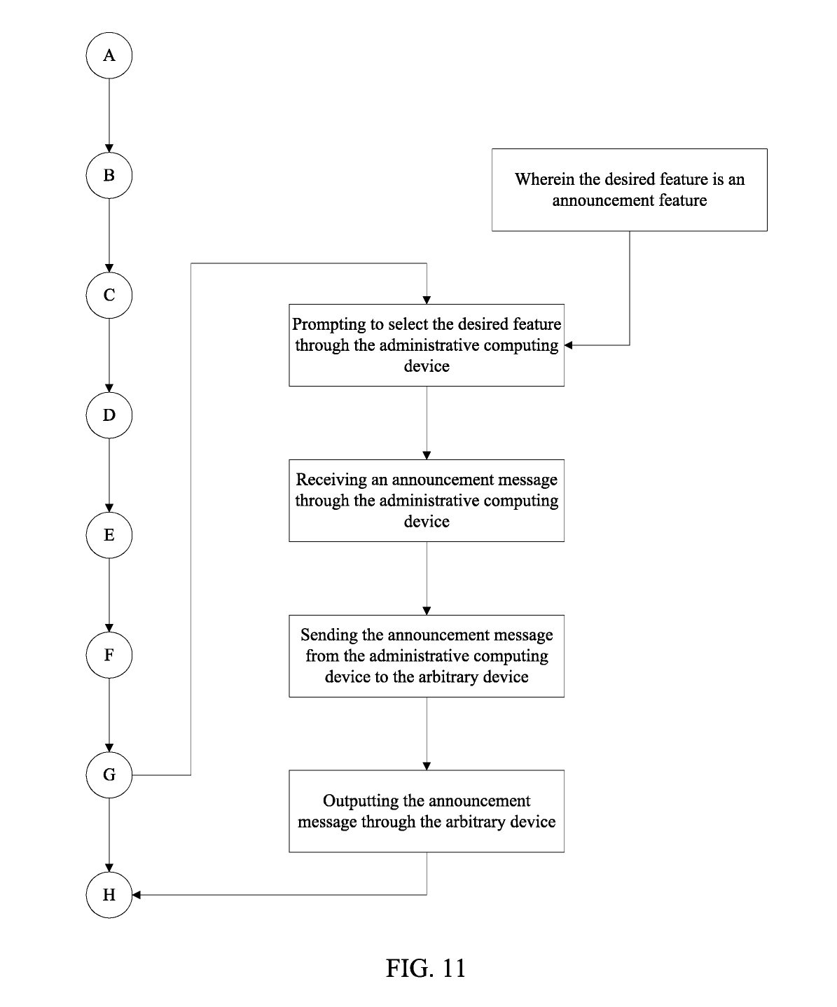

In reference to FIG. 11, an announcement feature is used to alert customers to shopping information and events. This can be used to notify consumers of sale events, store closure warnings, and various other alerts. When the desired feature is the announcement feature, the administrative computing device prompts the retailer to select the desired feature. The administrative computing device receives an announcement message from the retailer. The retailer may choose from pre-loaded announcement messages or create a custom announcement message. The announcement message is sent from the administrative computing device to the arbitrary device and the arbitrary device outputs the announcement message for consumers to see. This may be done for individual electronic retailer devices, a select number of electronic retailer devices, or store-wide, depending on the need of the retailer.

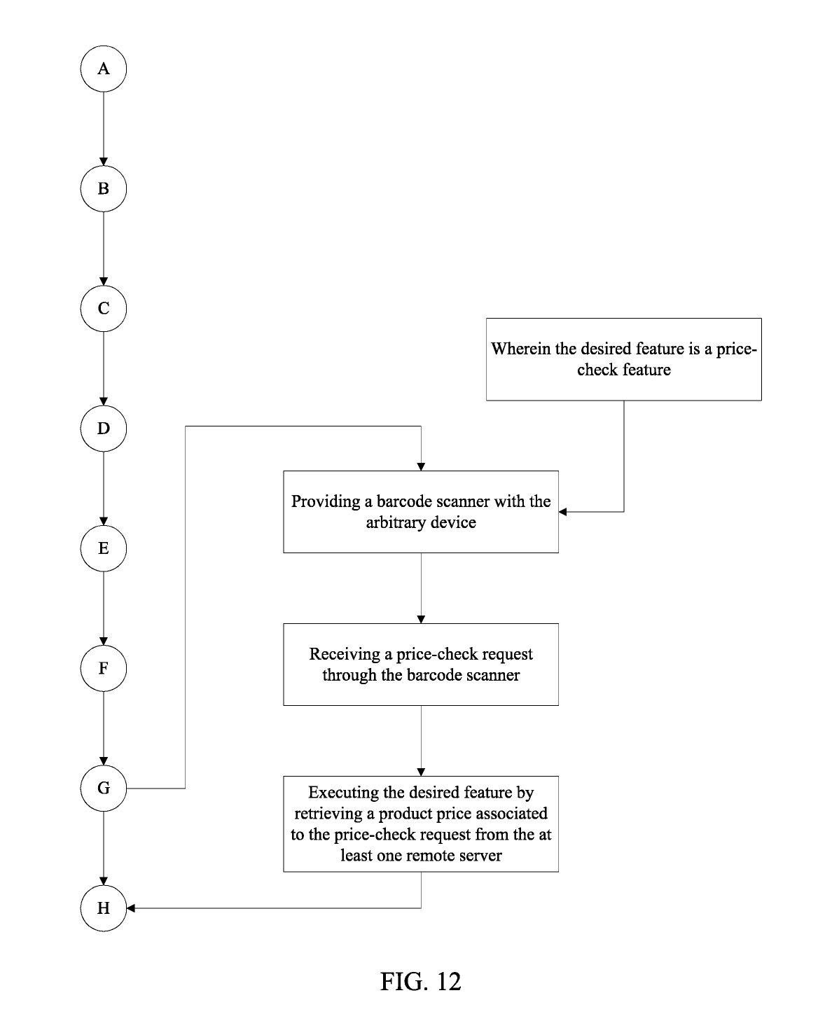

In reference to FIG. 12, a price-check feature is used to look up the price of a product. This may be useful for consumers who find unmarked items or if a sale is occurring. The arbitrary device comprises a barcode scanner which is used to identify the product being checked. When the desired feature is the price-check feature, a price-check request is received through the barcode scanner. The price-check request includes information pertaining to the barcode. The barcode scanner may be a traditional barcode scanner or may use a camera to analyze the barcode. The desired feature is executed by retrieving a product price associated to the price-check request from the remote server.

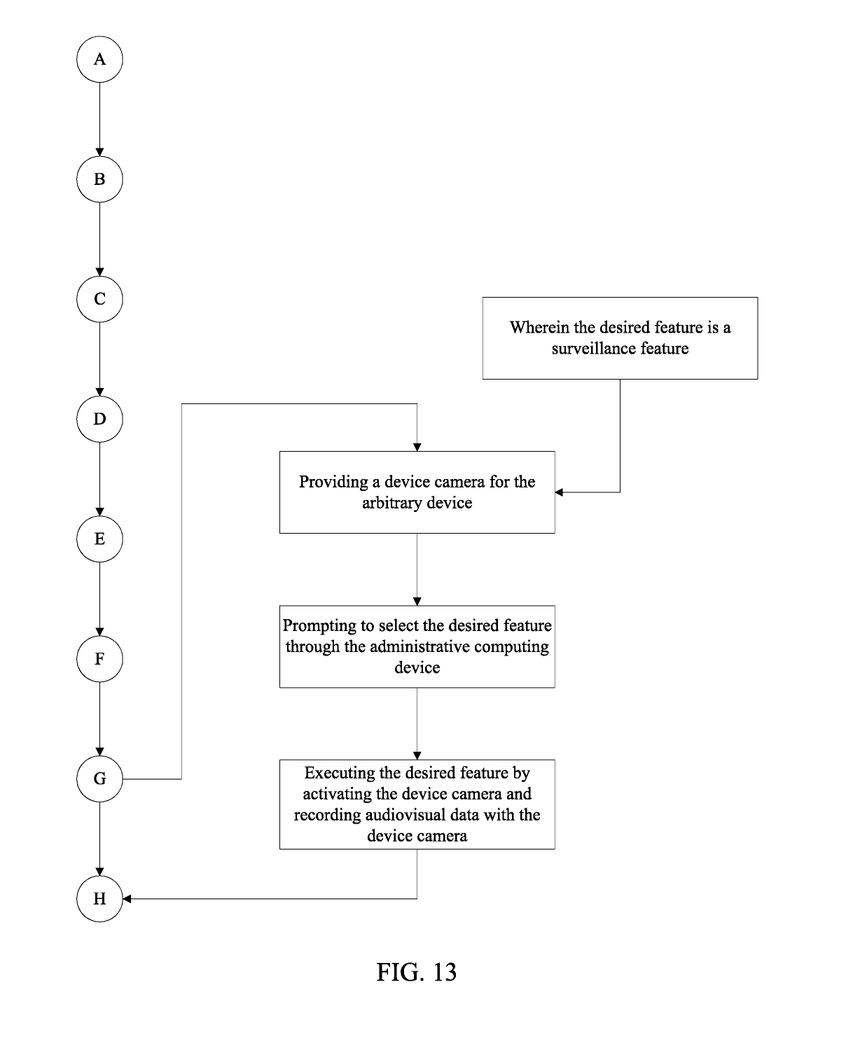

In reference to FIG. 13, a surveillance feature is used to monitor events within the store. The arbitrary device comprises a device camera which is used to record events within the store. When the desired feature is the surveillance feature, the retailer is prompted to select the desired feature through the administrative computing device. The surveillance feature may be used to monitor the store after hours or may operate continuously. The desired feature is executed by activating the device camera and recording audiovisual data with the device camera. The audiovisual data may then be saved locally or on the remote server.

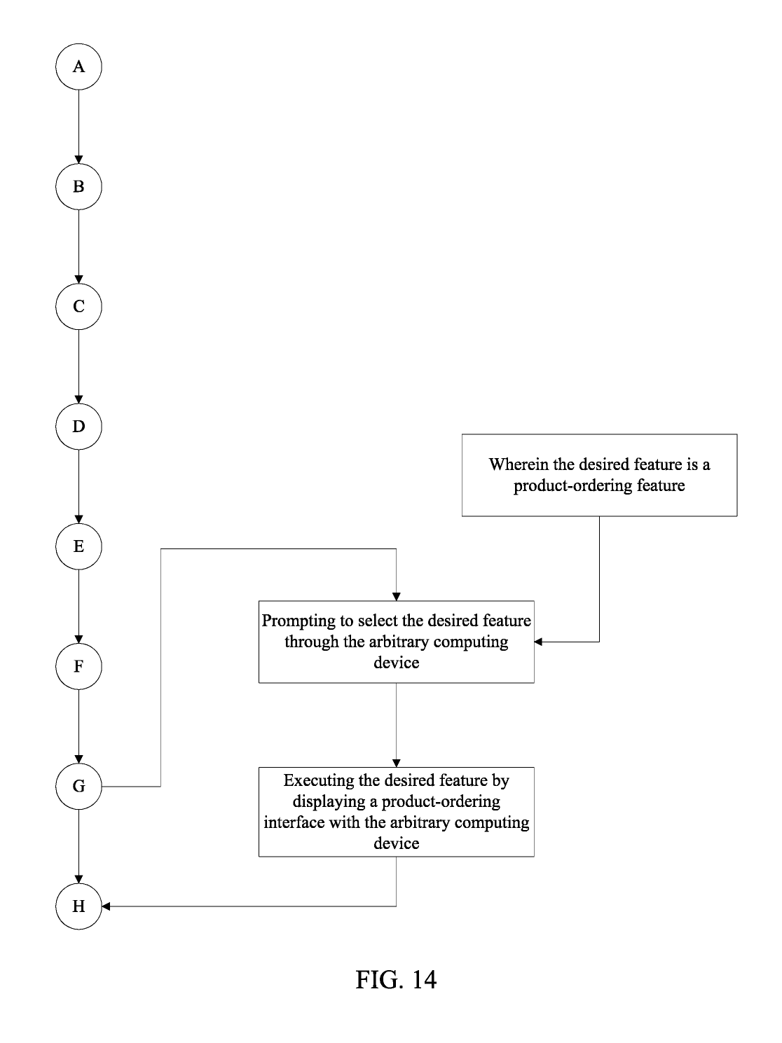

In reference to FIG. 14, a product-ordering feature is used to aid consumers in finding and purchasing products. When the desired feature is the product-ordering feature, the consumer is prompted to select the desired feature through the arbitrary computing device. The product-ordering feature may be used by consumers to order products online if said products are unavailable in-store. Alternatively, the product-ordering feature may be used to order products which are not on display or must be prepared before being purchased. The desired feature is executed by displaying a product-ordering interface with the arbitrary computing device. From the product-ordering interface, a consumer is able to easily select and order the product or products they wish to purchase.

The method of the present invention may be used in a number of other applications. For example, the surveillance feature may be used as a baby monitor. Further, facial recognition, which is used to initiate the virtual chat feature, may alternatively be used to recognize consumers and display personalized information. The facial recognition system may also be used to timestamp the arrival and departure of employees or admit employees into the store.

In order to provide a better shopping experience for consumers, each of the electronic retailer computing devices may be configured to interact with personal computing devices owned by consumers. Such interaction may be facilitated through the use of a mobile application. With the mobile application, consumers could retrieve pricing information by scanning barcodes or by researching the products they are looking to purchase.

Although the invention has been explained in relation to its preferred embodiment, it is to be understood that many other possible modifications and variations can be made without departing from the spirit and scope of the invention as hereinafter claimed.

What is claimed is:

1. A method of communicating to selected nodes in a mesh network, the method comprises the steps of:
(A) providing a plurality of electronic retailer devices, wherein the plurality of electronic retailer devices is managed by at least one administrative computing device;
(B) providing at least one remote server, wherein the at least one remote server manages a plurality of displayable content files and a plurality of additional feature options;
(C) prompting to select at least one desired file from the plurality of displayable content files through the administrative computing device;
(D) prompting to select a specific device from the plurality of electronic retailer devices through the administrative computing device;
(E) forwarding the desired file from the remote server to the specific device;
(F) outputting the desired file with the specific device;
(G) prompting to select a desired feature from the plurality of additional feature options through the administrative computing device or an arbitrary device, wherein the arbitrary device is any one of the plurality of electronic retailer devices; and
(H) executing the desired feature with either the administrative computing device or the arbitrary device, if the desired feature is selected during step (G) by either the administrative computing device or the arbitrary device.

2. The method of communicating to selected nodes in a mesh network as claimed in claim 1 comprises:
providing a product-based identifier for each of the plurality of electronic retailer devices; and
displaying the product-based identifier for each of the plurality of electronic retailer devices through the administrative computing device before step (D).

3. The method of communicating to selected nodes in a mesh network as claimed in claim 1 comprises:
providing a store location for each of the plurality of electronic retailer devices; and
displaying the store location for each of the plurality of electronic retailer devices through the administrative computing device before step (D).

4. The method of communicating to selected nodes in a mesh network as claimed in claim 1 comprises:
providing a vendor computing device and a store computing device as the at least one administrative computing device;
uploading at least one new displayable content file from the vendor computing device onto the remote server;
adding the new displayable content file to the plurality of displayable content files with the remote server; and
prompting to select the desired file from the plurality of displayable content files through the store computing device.

5. The method of communicating to selected nodes in a mesh network as claimed in claim 1 comprises:
providing a vendor computing device as the at least one administrative computing device;
uploading at least one new displayable content file from the vendor computing device onto the remote server;
adding the new displayable content file to the plurality of displayable content files with the remote server; and
prompting to select the desired file from the plurality of displayable content files through the vendor computing device.

6. The method of communicating to selected nodes in a mesh network as claimed in claim 1 comprises:
wherein the desired feature is a store assistance feature;
prompting to select the desired feature through the arbitrary device; and
executing the desired feature by sending an assistance request to the administrative computing device.

7. The method of communicating to selected nodes in a mesh network as claimed in claim 1 comprises:
wherein the desired feature is a virtual chat feature;
prompting to select the desired feature through the arbitrary device; and
executing the desired feature by managing a virtual communication session between the arbitrary device and the administrative computing device.

8. The method of communicating to selected nodes in a mesh network as claimed in claim 6 comprises:
providing a facial analysis system with the arbitrary device;
providing the plurality of neutral facial profiles and a plurality of unsettled facial profiles stored on each of the plurality of electronic retailer devices;
monitoring for a consumer facial profile within surroundings of the arbitrary device;
comparing the consumer facial profile to each of the plurality of unsettled profiles in order to identify a matching profile from the plurality of unsettled profiles; and
prompting to select the desired feature,
if the matching profile is found amongst the plurality of unsettled profiles.

9. The method of communicating to selected nodes in a mesh network as claimed in claim 1 comprises:
wherein the desired feature is an announcement feature;
prompting to select the desired feature through the administrative computing device;
receiving an announcement message through the administrative computing device;
sending the announcement message from the administrative computing device to the arbitrary device; and
outputting the announcement message through the arbitrary device.

10. The method of communicating to selected nodes in a mesh network as claimed in claim 1 comprises:
wherein the desired feature is a price-check feature;
providing a barcode scanner with the arbitrary device;
receiving a price-check request through the barcode scanner; and
executing the desired feature by retrieving a product price associated to the price-check request from the at least one remote server.

11. The method of communicating to selected nodes in a mesh network as claimed in claim 1 comprises:
wherein the desired feature is a surveillance feature;
providing a device camera for the arbitrary device;
prompting to select the desired feature through the administrative computing device; and
executing the desired feature by activating the device camera and recording audiovisual data with the device camera.

12. The method of communicating to selected nodes in a mesh network as claimed in claim 1 comprises:
wherein the desired feature is a product-ordering feature;
prompting to select the desired feature through the arbitrary computing device; and
executing the desired feature by displaying a product-ordering interface with the arbitrary computing device.
